(19) United States
(12) Patent Application Publication
(10) Pub. No.: US 2004/0217564 A1
(43) Pub. Date: Nov. 4, 2004

(54) Method of collecting groceries

(75) Inventors: Jeffrey Richard Ditges, Broomfield, CO (US); Joseph Michael Bollig, Highlands Ranch, CO (US)

Correspondence Address: J. Dwight Poffenberger, Jr., Wood, Herron & Evans, L.L.P., 2700 Carew Tower, 441 Vine St., Cincinnati, OH, 45202-2917, US

(73) Assignee: The Kroger Company, Cincinnati, OH

(21) Appl. No.: 10/862,296

(22) Filed: Jun. 7, 2004

Related U.S. Application Data
(62) Division of application No. 10/078,041, filed on Feb. 19, 2002.

(51) Int. Cl. B62B 3/00

(52) U.S. Cl. 280/79.3

(57) ABSTRACT

A method of collecting groceries from a grocery store to fill multiple orders simultaneously includes a wheeled cart. The cart body has at least one opening for storing totes to be filled with bags of groceries. The totes are taken to a delivery truck after being filled at the grocery store. The wheeled cart has an inverted U-shaped top rail to which are secured a printer and a scanner. A computer base secured to the cart supports a computer. The printer, scanner and computer are powered by a battery housed in the cart.

### CROSS-REFERENCE TO RELATED APPLICATIONS

This application is a divisional of U.S. patent application Ser. No. 10/078,041 filed Feb. 19, 2002 entitled “Wheeled Cart For Filling Grocery Orders”, which is fully incorporated by reference herein.

### FIELD OF THE INVENTION

This invention relates to wheeled carts for use in grocery stores to aid grocery store employees fill grocery orders for home delivery.

### BACKGROUND OF THE INVENTION

The conventional method of obtaining groceries is to drive or otherwise transport oneself to a grocery store. The grocery store carries or stocks all the desired groceries. After walking through aisles and choosing the items one desires to purchase, one checks out with an employee of the grocery store and after paying for the groceries, takes the groceries home for consumption.

With the widespread use of the Internet, a new method of obtaining one's groceries has been developed and practiced. Rather than traveling to a grocery store, one may now place a grocery order with a company over the Internet. The company will fill the order and then deliver the ordered groceries to the desired location, such as one's residence, for example. Several companies have provided such services.

Prior to the present invention wheeled carts have been used by employees of these companies inside grocery stores to fill grocery orders before the groceries are transported via vans to the homes of the individuals or families ordering them. Heretofore known wheeled carts have limited capacity to carry groceries, and furthermore, do not have any means to keep orders separate from one another. Consequently, a need exists for a wheeled cart which is capable of transporting multiple grocery orders arranged in an orderly fashion.

Therefore, it has been one objective of the present invention to provide a wheeled cart which has adequate capacity to separate, store and transport several orders of groceries in totes.

Further, it has been an objective of the present invention to provide a wheeled cart which is able to safely and efficiently store multiple totes, each tote being filled with a grocery order.

Further, it has been an objective of the present invention to provide a wheeled cart which a grocery store employee may quickly and efficiently use to fill multiple grocery orders simultaneously.

### SUMMARY OF THE INVENTION

The present invention comprises a wheeled cart adapted to store and transport groceries in totes for home delivery. The wheeled cart is intended for use in grocery stores; however, it may be used in any environment.

The wheeled cart comprises a body having at least one shelf for storing totes and a battery storage compartment adapted to store a battery. The body has a pair of front posts, a pair of rear posts, a bottom shelf, a top shelf, and a middle shelf. A rear handle is located at the rear of said body for pulling or pushing the cart to desired locations, i.e. down grocery store aisles.

The top and middle shelves along with the front and rear posts of the body define an upper opening adapted to store multiple totes. The bottom and middle shelves, the battery storage compartment and the front posts of the body define a lower opening adapted to store multiple totes.

The body of the wheeled cart is supported by multiple wheels arranged in a diamond shaped pattern. The front and rear wheels are caster wheels whereas the middle wheels are fixed in one orientation. Alternatively, other configurations of wheels of various types may be used to support the cart of the present invention.

A support in the form of an inverted U-shaped top rail is secured to said cart body and extends upwardly therefrom. The inverted U-shaped top rail has multiple accessories secured thereto including multiple bag holders, a scanner base for supporting a scanner, a printer base for supporting a printer. The inverted U-shaped top rail has a front handle for pushing or pulling the cart and holes therethrough at various locations to allow wires to pass through the top rail.

A computer base for supporting a computer is located at the front of said cart and secured to the cart body. The computer base may take the form of a caddy wrap inside which one may place pens, pencils, paper or any other loose items. Alternatively, the computer base may take other forms or designs. A swivel base is preferably secured to said computer base so that said computer may rotate.

In use, the operator of the cart pushes or pulls the cart using one of the handles to the desired aisle or location proximate the desired groceries. Once selected off the shelf, a grocery item is scanned by the scanner, thereby causing the item to be deleted from the computer monitor. The grocery item is placed in the appropriate bag supported by one of the bag holders. The bag is placed in one of the totes located in one of the cart openings. Once all of the ordered grocery items have been bagged and the bags placed in their appropriate totes, the operator may stop shopping. Presumably, all of the ordered grocery items from multiple orders will be deleted from the computer monitor.

Using this process, multiple orders may be filled simultaneously and accurately. Each tote resting on the cart is filled with an identifiable grocery order. A label printed by the printer is placed on each bag of groceries and a label is placed on each tote. Consequently, each bag of groceries is matched with a corresponding tote. Each tote is matched with a consumer's order. Once all the orders are filled, the totes are placed on a delivery truck with the labels easily visible by the delivery truck's driver. This process speeds delivery and ensures that each grocery order is delivered to the correct location.

These and other objects and advantages will be more readily apparent from the following description of the drawings.

### BRIEF DESCRIPTION OF THE DRAWINGS

FIG. 1 is a perspective view of the wheeled cart of the present invention including multiple accessories used with the cart.

FIG. 2 is a side elevational view of the wheeled cart of FIG. 1.

FIG. 3 is a bottom view of the wheeled cart of FIG. 1.

FIG. 4 a partially broken away perspective view of a portion of the rear of the cart of FIG. 1.

### DETAILED DESCRIPTION OF THE DRAWINGS

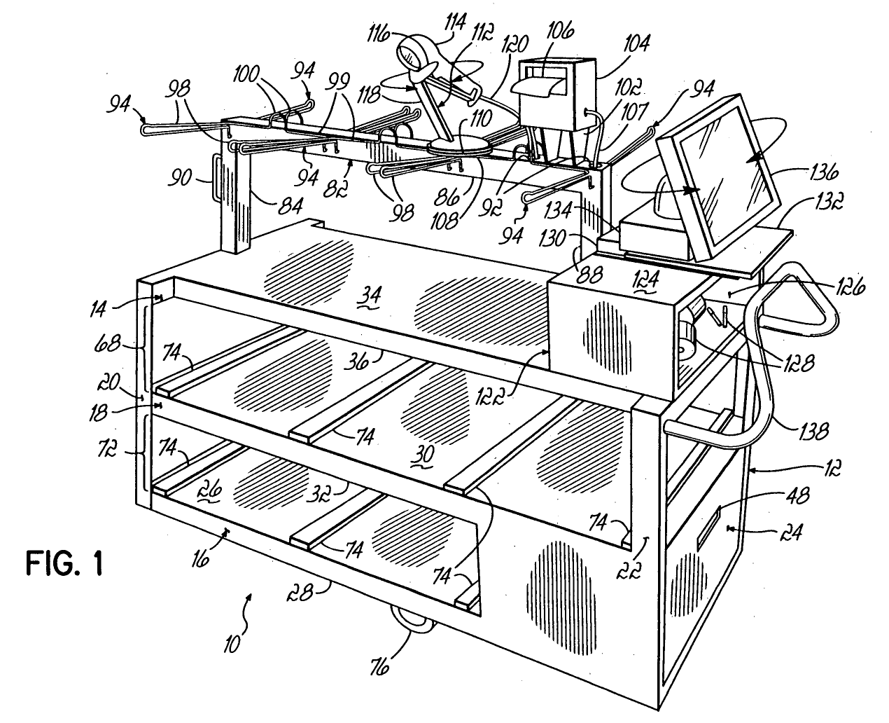

Referring to the drawings and particularly FIG. 1, a wheeled cart 10 is illustrated. The wheeled cart 10 is adapted to allow a person such as a grocery store employee to collect multiple grocery orders for home delivery, place the orders in bags, and place the bags in totes before the totes are placed on a delivery truck. The wheeled cart of the present invention has multiple features specifically designed to aid such an employee in collecting, bagging and storing in an organized manner multiple grocery items from the aisles of the grocery store so that the proper groceries may be delivered to the homes of customers. These features will be described in more detail below.

The cart 10 has a body 12 having a top shelf 14, a bottom shelf 16, a middle shelf 18, a pair of front posts 20, a pair of rear posts 22 and a battery storage compartment 24, shown in detail in FIG. 4. The front and rear posts 20, 22 support the top shelf 14 and the middle shelf 18. The bottom shelf 16 of the cart body 12 has an upper surface 26 and a lower surface 28. Similarly, the middle shelf 18 of the cart body 12 has an upper surface 30 and a lower surface 32. Similarly, the top shelf 14 of the cart body 12 has an upper surface 34 and a lower surface 36. As illustrated in FIG. 1, the width of the top shelf 14 is less than the width of the middle and bottom shelves 18, 16 respectively, to allow easy access to the totes residing on the middle shelf 18.

FIG. 4 illustrates the battery storage compartment 24 in detail. The battery storage compartment 24 has a bottom 38, top 40, back wall 42, side walls 44 and a front cover 46. The front cover 46 has a rectangular handle 48 to enable one to easily grasp the front cover 46 to remove it. Although one configuration of handle is illustrated and described, the handle may assume other forms or shapes. The front cover 46 has a generally planar front portion 50, a horizontally oriented top flange 52, a horizontally oriented bottom flange 54 and a pair of vertically oriented side flanges 56. In order to hold the front cover 46 in place, a pair of projections 58 project outwardly from the side flanges 56 of the front cover 46. These projections 58 are adapted to be received inside receptacles 60 integrally formed in the rear posts 22 of the cart body 12. Additionally, the front cover 46 has a pair of projections 62 extending downwardly from the top flange 52 which are adapted to be received inside slots 64 integrally formed in the middle shelf 18 of the cart body 12. Numerous other structures may be used in accordance with the present invention to secure the front cover 46 over the entrance to the battery storage compartment 24.

The battery storage compartment 24 is adapted to store a 12 volt DC battery 66 along with a converter (not shown) to change the voltage of the battery to 110 volts AC. One converter which has proven satisfactory is manufactured by Trip Lite under Part # UPSPV500. The preferred battery, converter and other accessories used in connection with the wheeled cart of the present invention may be changed or modified if necessary without departing from the spirit of this invention.

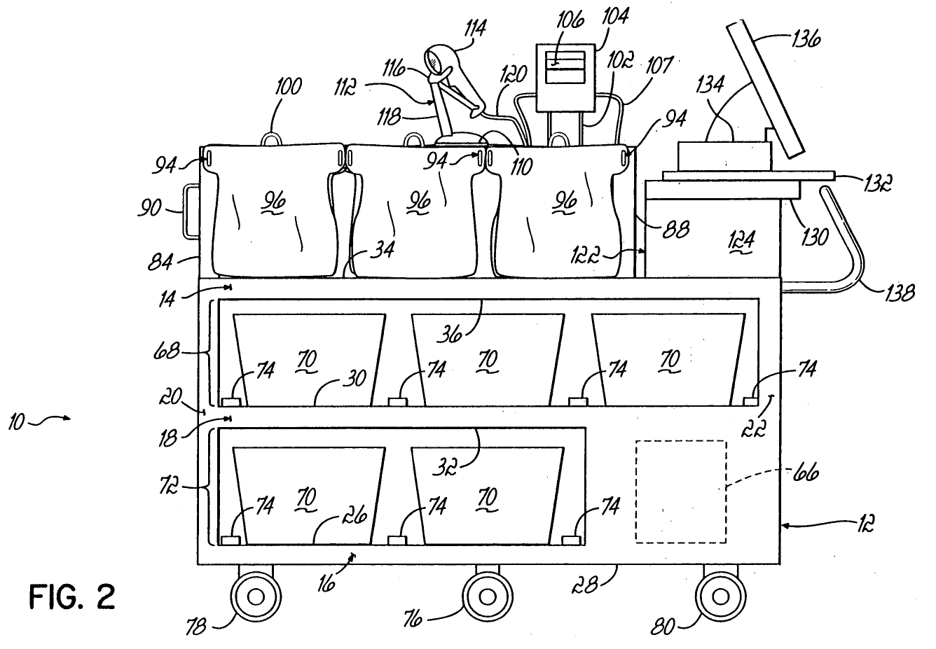

The front posts 20, rear posts 22, upper surface 30 of the middle shelf 18 and lower surface 36 of the top shelf 14 of the body 12 define an upper opening 68 adapted to store three totes 70 (see FIG. 2). Similarly, the front posts 20, back wall 42 of the battery storage compartment 24, lower surface 32 of the middle shelf 28 and upper surface 26 of the lower shelf 24 of the body 12 define a lower opening 72 adapted to store two totes 70. The size of the upper and lower openings 68, 72 may be varied to accomodate different numbers of totes or different sizes of totes or other containers, in accordance with the present invention. Removable dividers 74 are removably secured to the upper surfaces 26, 30 of the bottom and middle shelves 16, 18, respectively. The dividers 74 separate adjacent totes 70 from each other and inhibit front to back movement of these totes. Consequently, the totes 70 are slid onto and off the shelves from the sides.

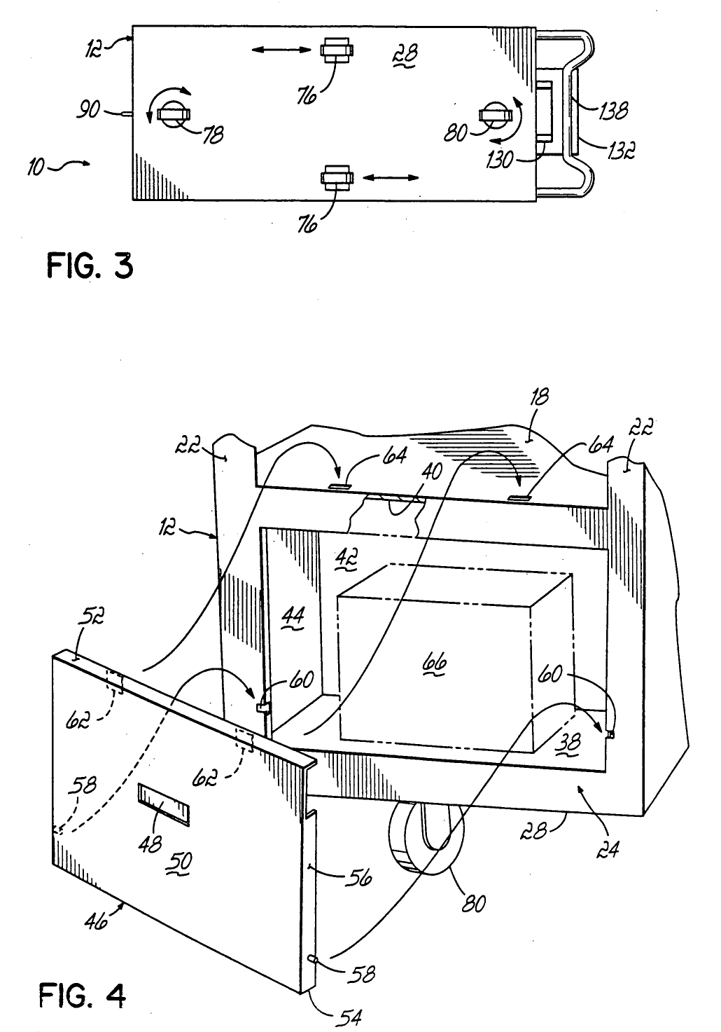

As illustrated in FIG. 3, the cart 10 is supported by two middle wheels 76, a front caster wheel 78 and a rear caster wheel 80 arranged in a diamond shaped arrangement. Each of the caster wheels, 78, 80 are able to rotate 360 degrees whereas the middle wheels 76 have a fixed longitudinally extending orientation such that they may not rotate 360 degrees. Although FIG. 3 illustrates the cart 10 being supported by four wheels, two of the wheels being caster wheels, the cart may be supported by any number of wheels of any type in accordance with the present invention. Additionally, supports other than wheels may be used.

An inverted U-shaped top rail 82 is removably secured to the top shelf 14 of the cart's body 12. However, the top rail 82 may be secured to other portions of the cart without departing from the spirit of the invention. Additionally, the top rail 82 may be other shapes or configurations. As best illustrated in FIG. 1, the inverted U-shaped top rail 82 includes a vertically oriented front portion 84, a horizontally oriented middle portion 86 and a vertically oriented rear portion 88. As illustrated in FIGS. 1 and 2, a front or pull handle 90 is secured to the front portion 84 of the top rail 82. As best illustrated in FIG. 1, the inverted U-shaped top rail 82 has multiple openings or holes 92 for passage of electrical wires or cords used to power the accessories described below.

A plurality of bag holders 94 are removably secured to the middle portion 86 of the inverted U-shaped top rail 82. Each of the bag holders 94 is adapted to support multiple plastic grocery bags 96 in a convention manner as shown in FIG. 2. Each bag holder 94 has a pair of end loops 98 between which is a center portion 99 having a semi-circle or bump 100. Although one configuration of bag holder 94 is illustrated and described, other types or configurations of bag holders may be utilized. Although six bag holders 94 are illustrated, three per side, any number of bag holders may be used in accordance with the present invention.

As best illustrated in FIG. 1, a printer base 102 is also secured to said top rail 82 for supporting a printer 104. Although any printer may be used in accordance with the present invention, one printer which has been used is manufactured by Encore and sold as model number E3H-OU1CV010-00. Although the printer 104 may be used for other purposes, the primary purpose of the printer 104 is to print labels 106 to be attached to the totes 70 and the bags 96. Power cords 107 supply power from the converter to the printer 104. The label 106 placed on each bag 96 identifies which tote 70 the bag of groceries belongs inside. Each tote 70 corresponds to an individual order.

Also illustrated in FIG. 1 is a scanner base 108 comprising a lower piece 110 and an upper piece 112. The lower piece 110 is fixedly secured to the top rail 82. The upper piece 112 is secured to the lower piece 110 such that the upper piece 112 may rotate. A scanner 114 is supported by a cradle 116 at the outer end of an arm 118 of the upper piece 112. A power cord 120 supplies power from the converter to the scanner 114. Although any scanner may be used in accordance with the present invention, one scanner which has been used is manufactured by Symbol and sold as model number LS-6004-1000-0700-ZN. This scanner 114 may be removed from the scanner base 108 and used remotely if desired.

As illustrated in FIG. 1 a computer base 122 is secured to the cart body 12 at the rear thereof. The computer base 122 comprises a stationary member or caddy 124 having an interior 126 into which various items 128 such as printer paper and writing utensils may be stored. Located on top of the caddy 124 and secured thereto is a rectangular shaped, stationary base member 130 which projects forwardly in front of the caddy 124. A lazy susan or swivel base 132 is pivotally secured to the base member 130 such that the swivel base 132 may rotate. A computer 134 including a monitor 136 rests on the swivel base so that the cart operator may rotate the computer monitor 136, thereby viewing it from any location. Although one configuration of computer base 122 is illustrated and described, other bases may be used in accordance with the present invention.

Although any type of computer 134 may be used in accordance with the present invention, one computer which has proven satisfactory is a Javelin Viper modular, low profile touch screen PC designed for high traffic sold under model number JAV-Viper64W98.

One more component of the wheeled cart 10 of the present invention is a rear or loop handle 138 secured to the body 12 of the cart 10. More particularly, the rear handle 138 extends rearwardly from the rear posts 22. Although one configuration of rear handle 138 is illustrated other types of handles may be used in accordance with the present invention.

In use, when a grocery store employee turns on the computer the appropriate software will list up to six orders which have been placed by individuals or businesses. To fill these orders simultaneously, an employee of the grocery store or similarly situated person will go the first aisle of the store and pick items off the shelves. As each item is selected or picked, the operator of the cart will scan the item, thereby causing the item to be deleted from the computer monitor. The operator will then place the item in the appropriately labeled bag. Once the bag is full, the operator will place the bag in one of the totes having a label corresponding to the label of the full grocery bag. Once all items of all the orders have been picked or selected, bagged and placed in their appropriate totes, then the computer is turned off. The filled totes are then placed on a truck or similar vehicle for delivery.

While we have described one preferred embodiment of the present invention, persons skilled in the art may appreciate minor modifications which may be made to the present invention without departing from the spirit of the invention. Therefore, we do not intend to be limited except by the scope of the following claims:

We claim:

1. A method of collecting groceries for home delivery using a wheeled cart, said method comprising:
scanning grocery items into a computer database;
placing said grocery items into bags supported by bag holders secured by said wheeled cart;
moving bags filled with groceries into totes located in openings in said wheeled cart; and
removing said totes full of groceries from said wheeled cart to a vehicle for delivery.

2. A method of collecting groceries for home delivery comprising:
providing a wheeled cart comprising
a body having at least one opening therethrough and a battery storage compartment,
wheels supporting said body,
a support secured to said body for supporting a plurality of bag holders, and
a computer base;
providing empty totes in said at least one opening of said wheeled cart;
providing a computer including a monitor supported by said computer base of said wheeled cart;
providing a scanner secured to said support of said wheeled cart;
scanning grocery items with said scanner into a computer database in said computer;
placing said scanned grocery items into bags supported by said bag holders to create filled bags;
moving said filled bags into said empty totes to create filled totes; and
removing said filled totes from said wheeled cart for home delivery.

3. The method of claim 2 wherein said wheeled cart is moved by an operator using a handle.

4. The method of claim 2 further comprising printing matching labels from a printer secured to said wheeled cart and placing some of said labels on said totes and others of said labels on said grocery bags.

5. The method of claim 4 further comprising placing filled grocery bags having labels in totes having labels matching the labels on the corresponding filled grocery bags.

6. A method of collecting groceries for home delivery comprising:
providing a wheeled cart comprising
a body having at least one shelf adapted to store multiple totes,
a battery storage compartment,
an inverted U-shaped top rail secured to said body and extending upwardly therefrom,
at least one bag holder secured to said inverted U-shaped top rail, and
a swivel base;
providing a computer including a monitor supported by said swivel base of said wheeled cart;
providing a scanner supported by inverted U-shaped top rail of said wheeled cart;
providing a battery in said battery storage compartment of said wheeled cart for powering said scanner and computer;
providing bags supported by said at least one bag holder;
providing empty totes supported on said at least one shelf of said wheeled cart;
scanning grocery items appearing on said computer monitor so as to delete such items off said computer monitor;
placing said scanned grocery items in bags supported by said at least one bag holder;
placing said bags filled with grocery items in said empty totes located on said at least one shelf of said wheeled cart; and
placing the filled totes on a delivery vehicle.

7. The method of claim 6 further comprising providing a printer supported by said wheeled cart and printing matching labels from said printer.

8. The method of claim 7 further comprising placing one of said matching labels on one of said empty totes and the other of said matching labels on one of said grocery bags in order to identify which grocery bags so in which totes.

9. A method of collecting groceries for home delivery comprising:
providing a wheeled cart;
providing a computer including a monitor supported by said wheeled cart;
providing a scanner supported by said wheeled cart;
providing a battery supported by said wheeled cart for powering said scanner and computer;
scanning grocery items with said scanner;
placing said scanned grocery items in bags supported by wheeled cart;
placing said bags filled with grocery items in empty totes supported by a portion of said wheeled cart; and
removing filled totes from said wheeled cart.

10. The method of claim 9 further comprising providing a printer supported by said wheeled cart and printing matching labels from said printer.

11. The method of claim 10 further comprising placing one of said matching labels on one of said totes and the other of said matching labels on one of said grocery bags and placing grocery bags in totes having matching labels.

12. A method of collecting groceries for home delivery comprising:
providing a wheeled cart;
providing a computer including a monitor supported by said wheeled cart;
providing a scanner supported by said wheeled cart;
providing a printer supported by said wheeled cart;
providing a battery supported by said wheeled cart for powering said scanner, printer and computer;
printing matching labels from said printer;
placing one of said matching labels on a tote supported by said wheeled cart and the other of said matching labels on a grocery bag supported by said wheeled cart;
scanning a grocery item with said scanner;
placing said scanned grocery item in said grocery bag;
placing said grocery bag in said tote; and
removing said tote from said wheeled cart.

13. A method of collecting groceries for home delivery using a wheeled cart, said method comprising:
moving a wheeled grocery cart to a desired location in a grocery store;
scanning a grocery item with a scanner secured to said wheeled cart;
placing said grocery item into a grocery bag supported by a bag holder secured by said wheeled cart;
placing said grocery bag containing said grocery item into a tote located in an opening in said wheeled cart; and
removing said tote from said wheeled cart to a vehicle for delivery.
